(19) United States
(12) Patent Application Publication
(10) Pub. No.: US 2002/0046261 A1
(43) Pub. Date: Apr. 18, 2002

(54) Portable electronic viewer system

(76) Inventors: Satoshi Iwata, Kawasaki (JP); Shoji Suzuki, Kawasaki (JP)

Correspondence Address: STAAS & HALSEY LLP, 700 11TH STREET, NW, SUITE 500, WASHINGTON, DC, 20001, US

(21) Appl. No.: 09/812,850

(22) Filed: Mar. 21, 2001

(30) Foreign Application Priority Data
Oct. 13, 2000 (JP) 2000-314078

(51) Int. Cl. G06F 15/16

(52) U.S. Cl. 709/219; 709/246

(57) ABSTRACT

A portable electronic viewer system is provided for satisfying both the demand for portability and the demand for containing a large volume of contents. The portable electronic viewer system comprises a portable server division (500) provided with a hard disk (502) of 2.5 inches or smaller for storing book-type information containing at least either images or characters and a viewer division (510) for displaying page-by-page the book-type information sent wirelessly from the portable server division at a transfer rate of less than 16 Mbps.

### BACKGROUND OF THE INVENTION

1. Field of the Invention

The present invention relates to a portable electronic viewer system for displaying electronic book-type contents.

Portable display devices have been being put into a practical use more and more as liquid crystal display panels have become larger and less expensive. On the other hand, contents such as general documents, photographs as well as books and magazines themselves are being electronically published, and the electronic contents are being read on electronic devices. A system according to the present invention is intended to enable electronic book-type contents to be read simply on a portable display device. In the following description, books, magazines, general documents, photographs and the like are generally referred to as book-type contents.

2. Description of the Related Art

As conventional portable viewers for browsing electronic documents, a PDA (Personal Digital Assistant), a portable viewer, and a notebook computer are known.

The PDA and portable viewer function to compliment a personal computer.

FIG. 1 shows an example of a system including a conventional PDA. In the figure, the PDA 11 is supplied with contents from a personal computer 12 and a kiosk terminal 13 via a cable.

FIG. 2 is a block diagram showing an example of the configuration of a conventional PDA 1. As shown in the figure, most of the PDAs comprise a CPU 21, a battery 22, a display panel 23, a display memory 24 and an interface 25. Document contents are stored in the display memory 24, and stored contents are displayed on the display panel 23.

A notebook computer (not shown) is a portable personal computer and comprises a CPU, a battery, a display device, a memory, an I/O device and the like, wherein document contents stored in the memory are displayed on a viewer created with software, so that a user can read them on the viewer.

On the other hand, the book-type contents displayed on the viewer are constituted by a plurality of pages. A page layout for each of the plurality of pages is one of pieces of information to be transmitted, and the layout must be recalled on the viewer. Conventionally, roughly speaking, there have been two types of contents formats for performing a viewer display like this: a format (image format) for retaining contents as an image, as shown in FIG. 3; and a format (layout retaining format) for retaining layouts, as shown in FIG. 4.

The image format shown in FIG. 3 is intended to retain contents as image information for expansion in the display memory. On the other hand, the layout retaining format shown in FIG. 4 is such that it retains layout information, image information and text information separately from each other in the format. The layout retaining format requires a format conversion process for expansion of the information in the image memory. On the other hand, with the image format, although expansion in image memory is not required, in general, the data volume is large.

In the case of a notebook computer, in order to realize personal computer functions other than the function to read books, in addition to the display function, an input/output unit, an interface module and the like need to be installed. Due to this, the size of the housing becomes large, when compared to the other two types, and this causes a problem that the display of contents is difficult while the computer is being carried by the user.

In the case of a PDA unit, since the input/output function other than the display function is limited as much as possible in order to grant priority to portability, there occurs no problem with the size of the housing, but since the capacity of a portable storage device is limited, there is generated a problem that it is difficult to retain a plurality of book-type contents. For example, in a general PDA, when a compact flash memory is installed therein, the capacity of a memory which can be currently installed therein is in the order of about 100 megabyte and, in terms of the number of books, this capacity allows only one book to be stored therein.

In view of the problems inherent in the prior art, an object of the present invention is to provide a portable electronic viewer system which can satisfy both the demand for portability and the demand for a large volume of contents based on an idea that a portable server division containing a contents storage unit and a viewer functioning to display the contents are separated but are connected wirelessly.

### SUMMARY OF THE INVENTION

With a view to attaining the object, according to a first aspect of the present invention, there is provided a portable electronic viewer system comprising a server division for storing, and transmitting and receiving book-type contents containing at least either images or characters and a viewer division for displaying the book-type contents transmitted wirelessly from the server division page by page.

Since the first aspect allows the storage of the book-type contents in the server division, the storage function of the viewer division can be reduced, as a result of which the portability and cost of the viewer division can be improved and reduced, respectively.

According to a second aspect of the present invention, there is provided a portable electronic viewer system as set forth in the first aspect, wherein the viewer division comprises a display memory for storing page-by-page information that is to be displayed on a display panel, a first wireless interface module and a first battery for supplying power to the display panel and the display memory, and wherein the server division comprises a disk for storing the book-type contents, a second wireless interface module, a computer processing unit for creating page-by-page information and a second battery for supplying power to the disk, the second wireless interface module and the computer processing unit.

Since the second aspect allows a small volume of information such as page-by-page information to be created and sent from the server division to the viewer division even if the wireless transmission rate is a low value such as 16 Mbps, a reader does not have to be kept waiting long before the information is displayed on the viewer division.

According to a third aspect of the present invention, there is provided a portable electronic viewer system as set forth in the second aspect, wherein the server division converts a data file having at least one of document layout information, document information, character information and image information into an intermediate data file constituted by part of information in an image in which a page constitutes a unit and transfers the intermediate data file so converted to the viewer division using the second wireless interface, and wherein the viewer division displays a page-by-page image by using the intermediate data file in the display memory.

Since the third aspect enables the transmission and reception of an intermediate data file whose information volume is smaller than that of the data file, even if the transfer capacity of the wireless interface is low, the reader does not have to be kept waiting long before the data is displayed.

According to a fourth aspect of the present invention, there is provided a server division for storing book-type contents containing at least either images or characters and transmitting the book-type contents to a viewer division wirelessly.

According to the fourth aspect, since the server division is separated from the viewer division, a large volume of book-type contents can be stored in the server division.

According to a fifth aspect of the invention, there is provided a viewer division for displaying book-type contents containing at least either images or characters which are sent from a server division page by page.

According to the fifth aspect, since the viewer division is separated from the server division, the viewer division can be light in weight, and as result, display is easy while the viewer division is being carried.

### BRIEF DESCRIPTION OF THE DRAWINGS

Other features, objects and advantages of the present invention will become apparent from the following description of preferred embodiments with reference to the drawings in which like reference characters designate like or corresponding parts throughout several views, and in which:

FIG. 1 is a diagram showing one example of a system including a conventional PDA,

FIG. 2 is a block diagram showing the configuration of the conventional PDA,

FIG. 3 is a diagram showing one example of a page image format,

FIG. 4 is a diagram showing one example of a layout retaining format,

FIG. 5 is a diagram showing the construction of a portable electronic viewer system according to a first embodiment of the present invention,

FIG. 6 is a diagram explaining a required time in a case where contents for one page are transferred from a portable server division to a viewer division,

FIG. 7 is a diagram explaining the browsing speed of a human being,

FIG. 8 is a diagram showing one example of a configuring method of an intermediate data file according to a second embodiment of the present invention,

FIG. 9 is a flowchart explaining a creating method of a hierarchical file according to a third embodiment of the present invention,

FIG. 10 is a flowchart explaining a browsing method of the hierarchical file according to the third embodiment of the present invention,

FIG. 11 is a flowchart explaining a creating method of a hierarchical file according to a fourth embodiment of the present invention,

FIG. 12 is a flowchart explaining a browsing method of the hierarchical file according to the fourth embodiment of the present invention,

FIG. 13 is a flowchart explaining a creating method of a hierarchical file according to a fifth embodiment of the present invention,

FIG. 14 is a flowchart explaining a browsing method of the hierarchical file according to the fifth embodiment of the present invention,

FIG. 15 is a flowchart explaining a creating method of a hierarchical file according to a sixth embodiment of the present invention,

FIG. 16 is a flowchart explaining a browsing method of the hierarchical file according to the sixth embodiment of the present invention,

FIG. 17 is a flowchart explaining a creating method of a hierarchical file in a case where the sixth embodiment of the present invention is configured as two layers of a thinned-out image and another image,

FIG. 18 is a flowchart explaining a browsing method of a hierarchical file created according to the flowchart of FIG. 17,

FIG. 19 is a flowchart explaining a creating method of a hierarchical file according to a seventh embodiment of the present invention,

FIG. 20 is a flowchart explaining a browsing method of the hierarchical file according to the seventh embodiment of the present invention,

FIG. 21 is a block diagram showing the configuration of a portable electronic viewer system according to an eighth embodiment of the present invention,

FIG. 22 is a flowchart explaining a creating method of a hierarchical file according to the eighth embodiment of the present invention,

FIG. 23 is a flowchart explaining a browsing method of the hierarchical file according to the eighth embodiment of the present invention,

FIG. 24 is a block diagram showing the configuration of a portable electronic viewer system according to a ninth embodiment of the present invention,

FIG. 25 is a flowchart explaining a creating method of a hierarchical file according to the ninth embodiment of the present invention,

FIG. 26 is a flowchart explaining a browsing method of the hierarchical file according to the ninth embodiment of the present invention,

FIG. 27 is a flowchart explaining a creating method of a hierarchical file according to a tenth embodiment of the present invention,

FIG. 28 is a flowchart explaining a browsing method of the hierarchical file according to the tenth embodiment of the present invention,

FIG. 29 is a flowchart explaining a creating method of a hierarchical file according to an eleventh embodiment of the present invention,

FIG. 30 is a flowchart explaining the flow of a process when a viewer division grants permission for publication in the eleventh embodiment of the present invention,

FIG. 31 is a flowchart explaining the flow of a process when a portable server division dials a hierarchical file in the eleventh embodiment of the present invention,

FIG. 32 is a flowchart explaining a creating method of a hierarchical file according to a twelfth embodiment of the present invention, and

FIG. 33 is a flowchart explaining a browsing method of the hierarchical file according to the twelfth embodiment of the present invention.

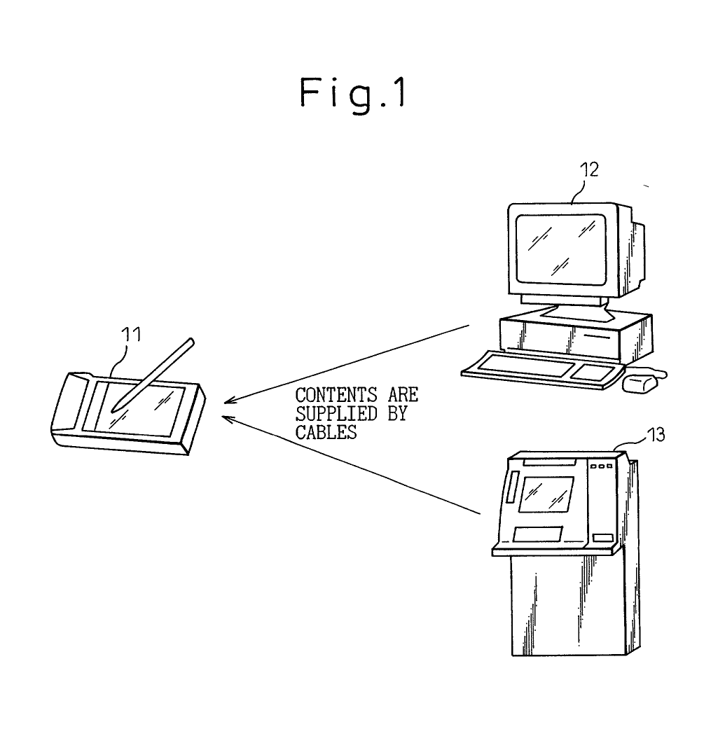

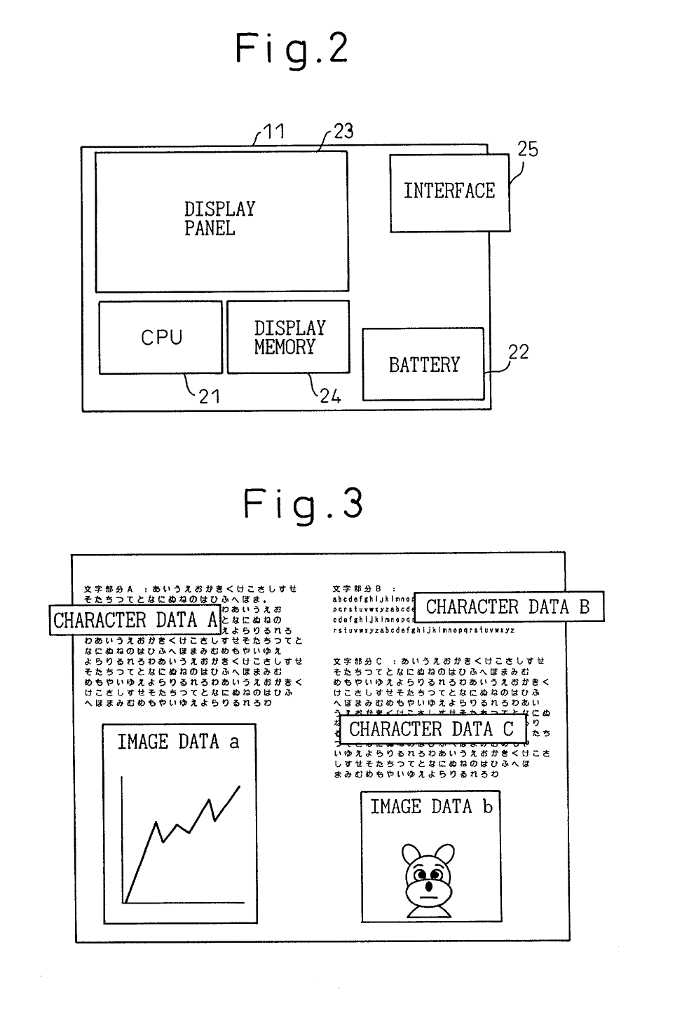

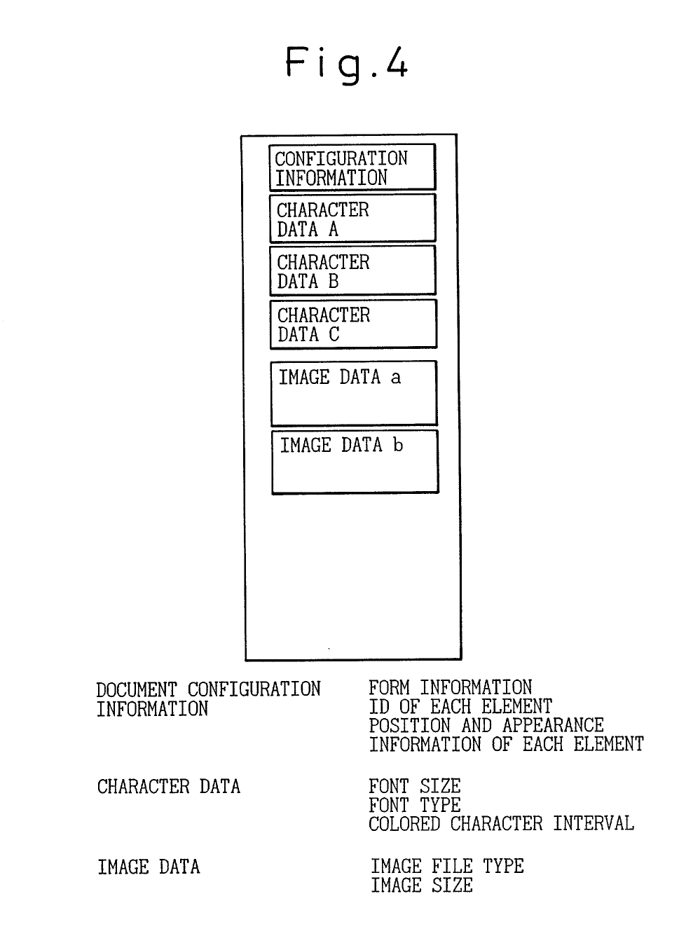

### DESCRIPTION OF THE PREFERRED EMBODIMENTS

Embodiments of the present invention will be described below with reference to the accompanying drawings.

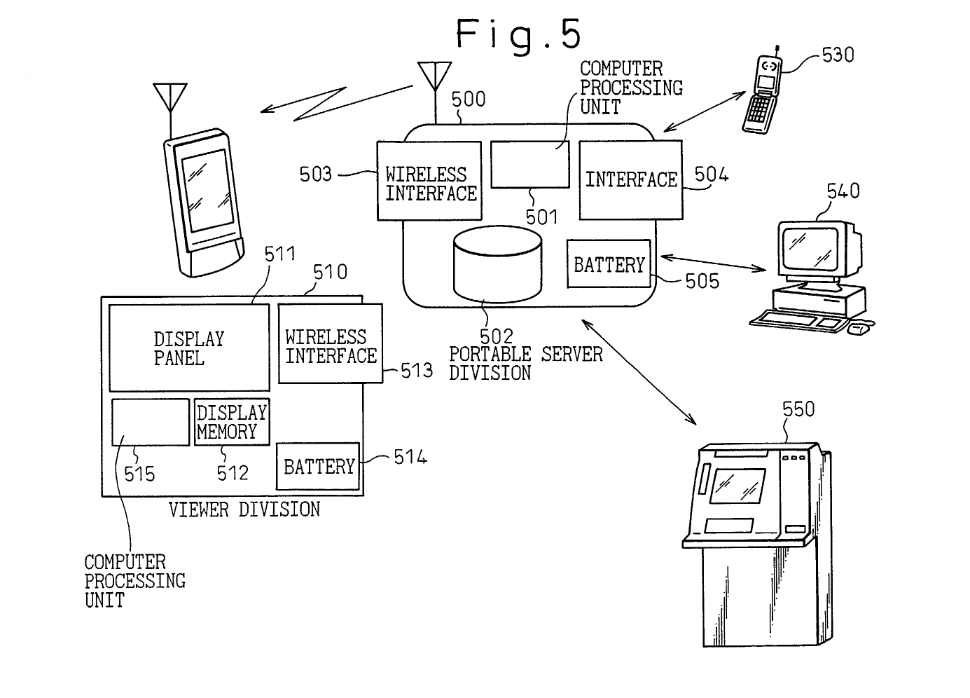

FIG. 5 is a diagram showing the configuration of a portable electronic viewer system according to a first embodiment of the present invention.

In the figure, the system comprises a portable server division 500 for storing, and transmitting and receiving, book-type contents containing at least either images or characters and a viewer division 510 for displaying, page by page, the book-type contents sent wirelessly from the server division.

The server division 500 exchanges information containing at least either images or characters with a portable or mobile telephone 530, a personal computer 540 or an information kiosk terminal 550. The viewer division 510 displays page by page information sent wirelessly from the portable server division 500.

The portable server division 500 comprises a computer processing unit 501, a contents storage unit 502 which is a hard disk of 2.5 inches or smaller, a wireless interface 503, an interface 504 for an external unit and a battery 505 which has a weight allowing the portable server division 500 to be carried even if the battery is installed in the portable server division 500. The battery having such a weight can supply power for driving a hard disk of 2.5 inches or smaller. In addition, the hard disk of 2.5 inches or smaller has a large storage capacity sufficient for storage of book-type contents or the like. Since the hard disk 502 of 2.5 inches or smaller is small in size, even when it is installed in the portable server division 500, there will be caused no problem in carrying the portable server division 500. Consequently, although it is too heavy to be hand carried, the portable server division 500 can be carried in a bag.

The viewer division 510 comprises a display panel 511 which is typically a flat panel-type viewer, a display memory 512, a wireless interface module whose transfer rate is less than 16 Mbps, a battery 514 having a weight enabling the viewer division 510 to be hand carried and a computer processing unit 515. Required contents are sent from the server division 500 to the viewer division 510 via wireless connection, whereby the contents can be displayed on the viewer division 510, and therefore, a solid memory may be used as the display memory 512 which is installed in the viewer division 510. Consequently, the viewer division 510 can be light in weight and inexpensive, whereby the viewer division 510 can be hand carried.

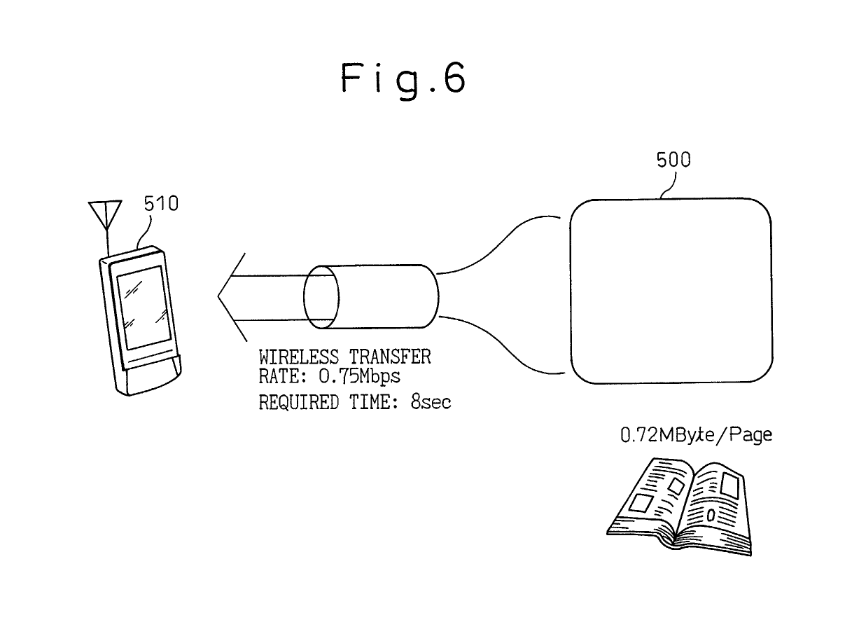

However, the wireless interface has a limited transfer capacity. Due to this, in a case where contents are transferred from the server division 500 to the viewer division 510 through the wireless interfaces 503 and 513, it is difficult to display a screen momentarily while transferring contents. In the Bluetooth Standard, the data transfer rate is 10 Mbps at the most and, with a low power consumption type, the actual value of the transfer rate is in the order of 0.75 Mbps. In a case where book-type contents of 100 pages, which are 72 megabyte, are transferred as they are with a data transfer rate of 0.75 Mbps, as shown in FIG. 6, a long period of 8 seconds will be required for the transfer.

Then, in order to reduce the aforesaid required transfer time, according to a second embodiment of the present invention, an intermediate data file is configured in which contents are layered in consideration of the book browsing method of human beings, and a wireless transfer is designed to be carried out for each hierarchy.

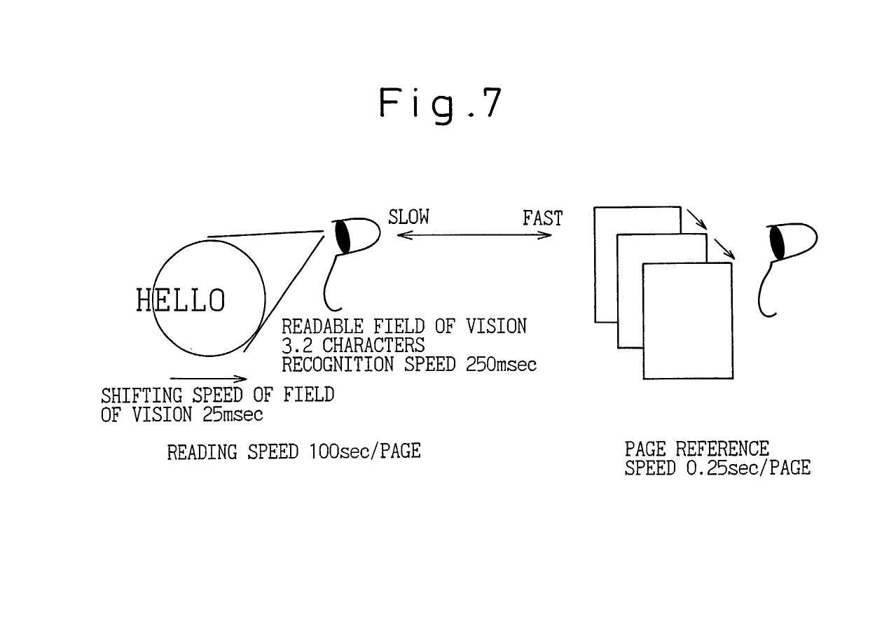

FIG. 7 is a diagram for explaining the book browsing method of human beings. As shown therein, when browsing a book page by page, human beings are considered to read the book in a plurality of ways of reading as will be described below.

Way of Reading No. 1: Read the Whole of Book-type Contents

In this way of reading, reading is carried out while following sentences with the eyes. When reading characters, as shown in FIG. 7, the number of characters which human beings can read at one time is about 3.2 characters, the holdup time of the eyes is 250 milliseconds, and the shifting time of the eyes is in the order of 25 milliseconds. Since the number of characters per page is 1200 (paper of B5 size) to 2600 (paper of B4 size), a required time to read characters per page using this way of reading is 100 to 200 seconds.

Way of Reading No. 2: Read only Title Portions or Image Portions of Book-type Contents

This way of reading is used to grasp the summary of each page by reading only main headlines or looking at images. For example, in a case where contents are information magazines, the whole page is not browsed but only the names of shops are referred to. In a case, for example, where there are five headlines of 20 characters per page, a required browsing time per page is in the order of eight seconds in this way of reading.

Way of Reading No. 3: The Contents of Book-type Contents are not Grasped but the Whole Page is Roughly Observed

In this way of reading, the meaning of a document is not understood but contents are roughly observed by turning pages. For example, only images are looked at or only the page configuration is referred to with a view to seeing if it is a column or a main part of an article. In this way of reading, since only one pattern is recognized without shifting the eyes, the browsing time per page is short, for example, in the order of 0.25 seconds.

In the second embodiment of the present invention, by paying an attention to the difference in way of reading as described above, an intermediate data file is created in which document contents are layered by element of a document, and an image transfer according to the way of reading is carried out, whereby even when an interface is used in which the transfer rate is limited, a momentary display is made possible. In other words, images are displayed on the viewer division 510 in a hierarchical order, the transfer is stopped at a position where a user intentionally stops the display and the following page is transferred, whereby pages can be ejected without the user being aware of waiting time in transferring images.

For example, character information (font information) and layout information are extracted from book-type contents, the largest font size of those contained therein is detected from the font size, text information corresponding to the largest font size is extracted, and what is so extracted is made to be an image data of a first hierarchy together with the layout information.

Next, image information is cut out of the book-type contents configured by units of pages, so that what is so cut out is made to be image data of a second hierarchy.

Furthermore, all the contents information is made to be an image data of a third hierarchy.

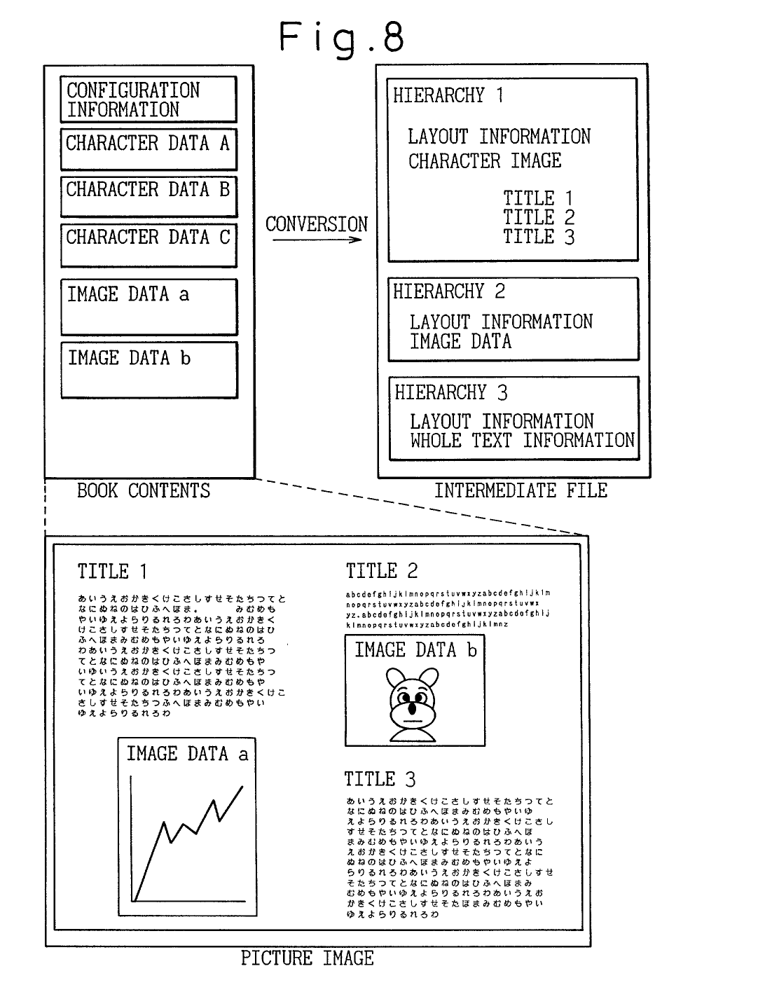

FIG. 8 is a diagram explaining one example of a configuring method of an intermediate data file according to the second embodiment of the present invention. As shown at a lower side of the figure, a picture image of one page comprises titles 1 to 3, character data comprising in turn character contents under the respective titles and image data a and b. Constituent information of the book-type contents of this picture image comprises character data A to C and image data a and b, as shown on the left-hand side of an upper side of the figure. The book-type contents are made to be intermediate data files, so that intermediate data files of hierarchy 1 to hierarchy 3 are created. The intermediate data files on the respective hierarchies are constituted by image files which can be expanded in the display memory 512 within the viewer 510. The intermediate data file on the hierarchy 1 comprises layout information and the character images of the titles 1 to 3. The intermediate data file on the hierarchy 2 comprises layout information and the image data. The intermediate data file on the hierarchy 3 comprises layout information and text information of the whole sentences.

For example, in a case where there are contents configured by a viewer size of 800×600 dots and 10 inches, a image size of 25%, five titles of 10 characters (72 dpi and the font size is 16 points) and the total characters per page of 1200 characters, the transfer capacity for transferring the first hierarchy is 30 kilobits, the transfer capacity for transferring the second hierarchy is 180 kilobits, and the transfer capacity for transferring the third hierarchy is 540 kilobits.

The intermediate data files are transferred sequentially from the hierarchy 1 from the portable server division 500 to the viewer division 510 in a wireless fashion, and at the viewer division 510, the intermediate data files of the respective hierarchies are expanded in the display memory 512 as soon as they are transferred thereto. Namely, first of all, the data on the hierarchy 1 is transferred, and only the intermediate data file on the hierarchy 1 is expanded in the display memory 12 at the viewer division 510 for display on the display panel 511. Next, the image on the hierarchy 2 is transferred to be written in the display memory 512. The display of the intermediate data file on the hierarchy 1 is the result of embodying the way of reading No. 3. The transfer rate, for example, in the Bluetooth actual transfer rate, is in the order of 0.04 seconds for a transfer. In a case where a browser intentionally ejects pages, the transfer is interrupted in the middle of transfer of the hierarchy which is being transferred, and a transfer process of the following page is started.

Thus, the portable server division 500 transforms the data file having at least one of the document layout, document information, character information and image information into the intermediate data file constituted by part of information in the image comprising units of pages, the intermediate data file so transformed is then transferred to the viewer division 510 using the wireless interface 503, and the viewer division 510 displays the image comprising units of pages by describing the intermediate file so transferred on the display memory 512, whereby since the intermediate data file whose information volume is smaller than that of the data file is transmitted and received, even if the transfer capacity of the wireless interface is small, the browser does not have to be kept waiting for data display.

Next, a third embodiment of the present invention will be described below. According to the third embodiment, in layering as described above, as will be described, intermediate data files are configured by layering character information of original image information in accordance with the size of character font, whereby an intermediate data file having larger characters layered is granted priority in transfer.

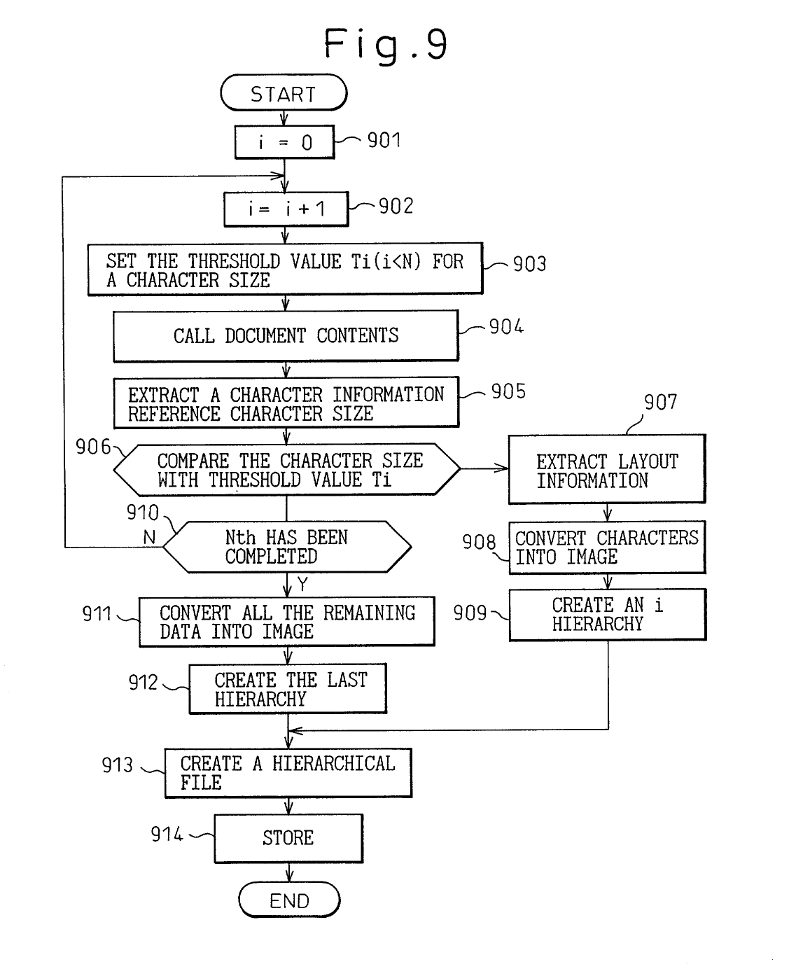

FIG. 9 is a flowchart explaining a layering method in which layering is carried out based on sizes of characters. This method is realized by the portable server division 500. In FIG. 9, in step 901, i is initialized as 0, in step 902, 1 is added to i, and in step 903, the threshold value Ti of the character size is set. Here, i is the number of a hierarchy, and the maximum hierarchical number is N. Next, in step 904, the document contents are called from the contents storage unit 502, which is a hard disk. Note that in the specification, the document contents mean the aforesaid the book-type contents. Next, in step 905, the computer processing unit 501, which is a computer processing unit, extracts sizes of characters by referring to the character information. Next, in step 906, the sizes of characters so extracted are compared with the threshold value, and in step 907, layout information (position information) of characters having sizes which are larger than the threshold value. Next, in step 908, font information and text information on characters having sizes which are larger than the threshold value are extracted to be converted into images, whereby in step 909, an intermediate data file for the i hierarchy is created.

In the event that it is determined in step 906 that no character whose size is equal to or larger than the threshold Ti exists in the document contents, then the process advances to step 910 and, in the event that i is not N, it returns to step 902, and the following hierarchy is created by repeating the process from steps 903 to 909 by incrementing i.

When the creation of the Nth hierarchy has been completed in step 910 then, in step 911, all the remaining data are converted into images and, in step 912, the last hierarchy is created. The intermediate data file of hierarchy i prepared in step 909 and the intermediate data file of the last hierarchy prepared in step 913 are brought together as a hierarchical file in the same step, and the hierarchy file is then retained in the contents storage unit 502 or the memory within the portable server division 500.

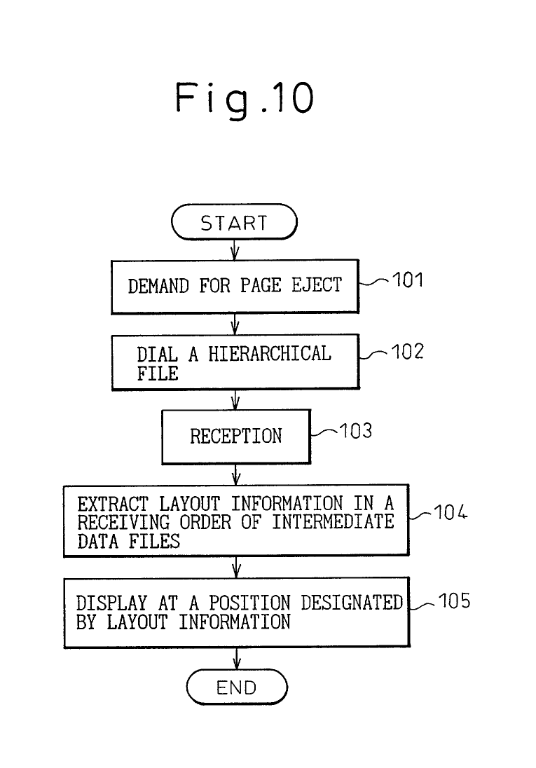

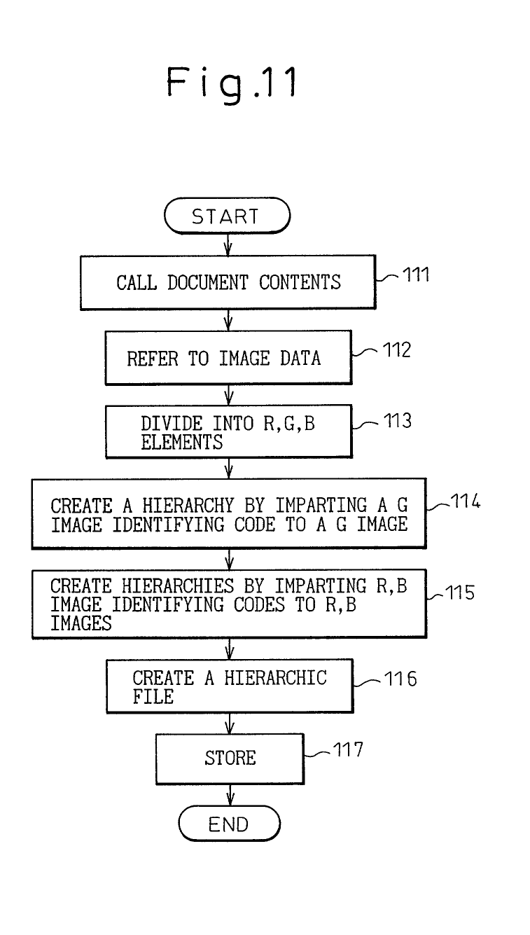

FIG. 10 is a flowchart explaining a browsing method of a hierarchical file according to the third embodiment described above. In the figure, in step 101, a page call signal is sent from the viewer division 510 through the wireless interface 513, whereby a demand for page eject is made to the portable server division 500. Next, when the portable server division 500 receives this signal in step 102, a hierarchical file is transmitted through the wireless interface 503, and the viewer division 510 receives the file in step 103. At the viewer division 510, every time a hierarchical file is received thereat, the hierarchical file so received is then described in the display memory 512. Hierarchical files after hierarchy 2 are overwritten on the display memory 512. Note that the description to the display memory 512 is carried out relative to an address designated by the layout information. The layout information is extracted in the order in which the hierarchical files are received in step 104, and a character image is displayed at a position designated by the layout information so extracted.

Next, a fourth embodiment according to the present invention will be described. According to the fourth embodiment, the aforesaid intermediate data files are created by separating a hierarchy of an image for a green element in a color image from hierarchies of images for elements other than the green element so that they become different hierarchies. This embodiment is based on the fact that a green image is most attractive to the eyes of human beings.

FIG. 11 is a diagram explaining a creating method of a hierarchical file according to the fourth embodiment. In the figure, in step 111, document contents are called from the contents storage unit 502 within the portable server 500, and image data is extracted from the document contents in step 112. Next, in step 113, the image data so extracted is decomposed into red, green and blue (R, G, B) components, and the image data of G is separated from the other image data. Then, in step 114, a G image identifying code is imparted to the G image so as to create a hierarchy. Next, in step 115, an R image identifying code and a B image identifying code are imparted to the R and B images, respectively, so as to create hierarchies. Then, in step 116, a hierarchical file is created, and in step 117, the hierarchical file so created is stored in the contents storage unit 502 or in the memory (not shown in FIG. 5).

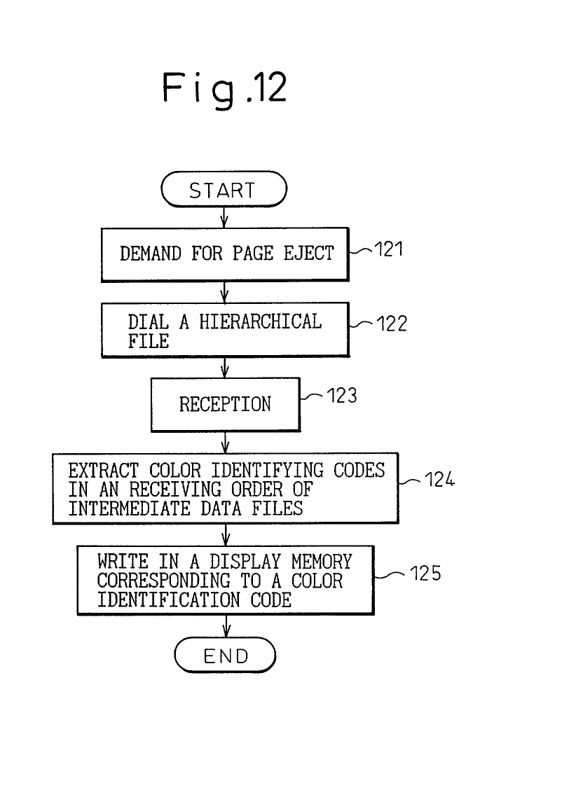

FIG. 12 is a diagram explaining a browsing method of the hierarchical file according to the fourth embodiment described above at the viewer division 510. In the same figure, step 121 to step 123 are identical to step 101 to step 103 described in FIG. 10, and therefore, a description of step 121 to step 123 will be omitted. At the viewer division 510, in step 124, every time the intermediate data files are received, color identifying codes are extracted in the order in which the intermediate data files are received and, in step 125, an image data is written in an address in the display memory 512 (a green displaying address for a green image) corresponding to the color identifying code within the display memory 512. Images after hierarchy 2 are overwritten in the display memory 512.

According to the fourth embodiment, since displaying the green image first or the like is made possible, the entirety of an image can be displayed with no waiting time.

Next, a fifth embodiment of the present invention will be described. According to the fifth embodiment, as the aforesaid intermediate data files, intermediate data files are configured such that an image portion and a character portion are in intermediate data files of different hierarchies, and priority is granted to the transfer of an intermediate data file of the image portion. This embodiment is based on the fact that images are more attractive to the eyes of human beings than characters.

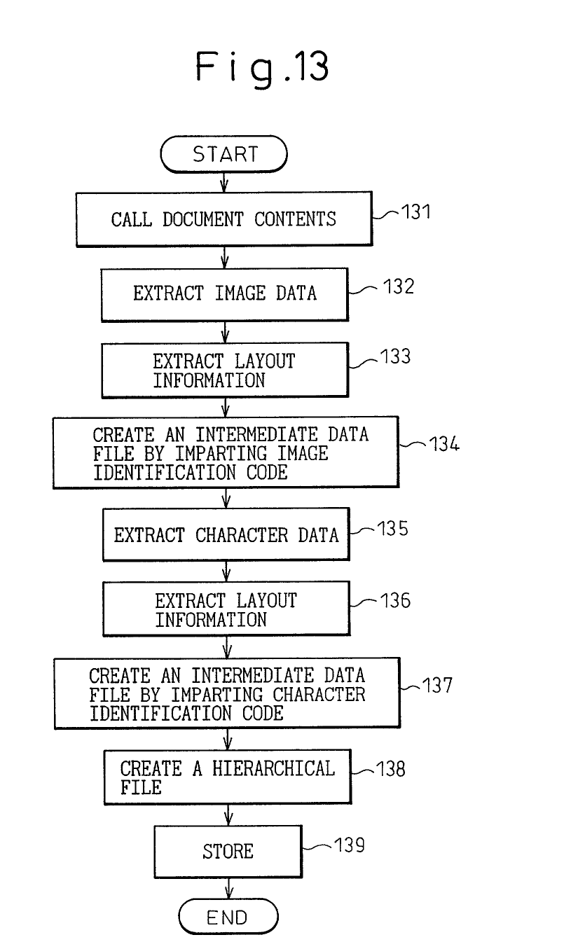

FIG. 13 is a flowchart explaining a creating method of the hierarchical file according to the fifth embodiment. In the same figure, in step 131, document contents are called from the contents storage unit 502 in the portable server 500 and, in step 132, image data are extracted from the document contents. Next, in step 133, layout information is extracted from the image data. Then, in step 134, an image identifying code is imparted to this layout information to create an intermediate data file of one hierarchy. Next, in step 135, the layout information is extracted from the contents storage unit 502 and, in step 137, a character identifying code is granted to the layout information to create an intermediate data file of another hierarchy. Then, in step 138, intermediate files of different hierarchies from each other are integrated as a hierarchical file, and in step 139, the hierarchical file is then retained in the contents storage unit 502 or the memory within the portable server division 500.

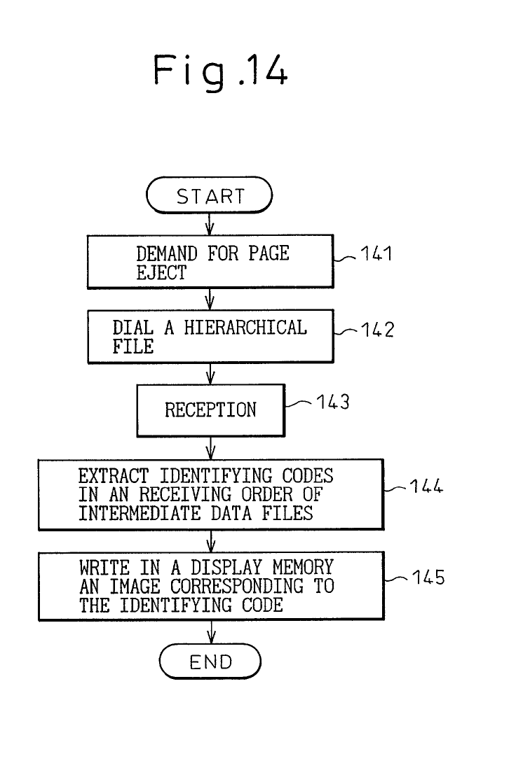

FIG. 14 is a flowchart explaining a browsing method of the hierarchical file according to the fifth embodiment described above at the viewer division 510. In the same figure, the browsing method is different from that described in FIG. 12 only in that writing in the display memory 512 is effected using the color identifying codes, while in the browsing method in FIG. 14, writing in the display memory 512 is effected using image and character identifying codes, and therefore, a description of the browsing method will be omitted.

According to the fifth embodiment, since either images or characters can be displayed first according to the method of browsing the contents, the serviceability of the viewer division is improved.

Next, a sixth embodiment of the present invention will be described. According to the sixth embodiment, the viewer division 510 has a function to write in the display memory 512 from transferred intermediate data files for each address at predetermined intervals, and the portable server division 500 configures intermediate data files in which data are layered for each address at intervals identical to the aforesaid predetermined intervals.

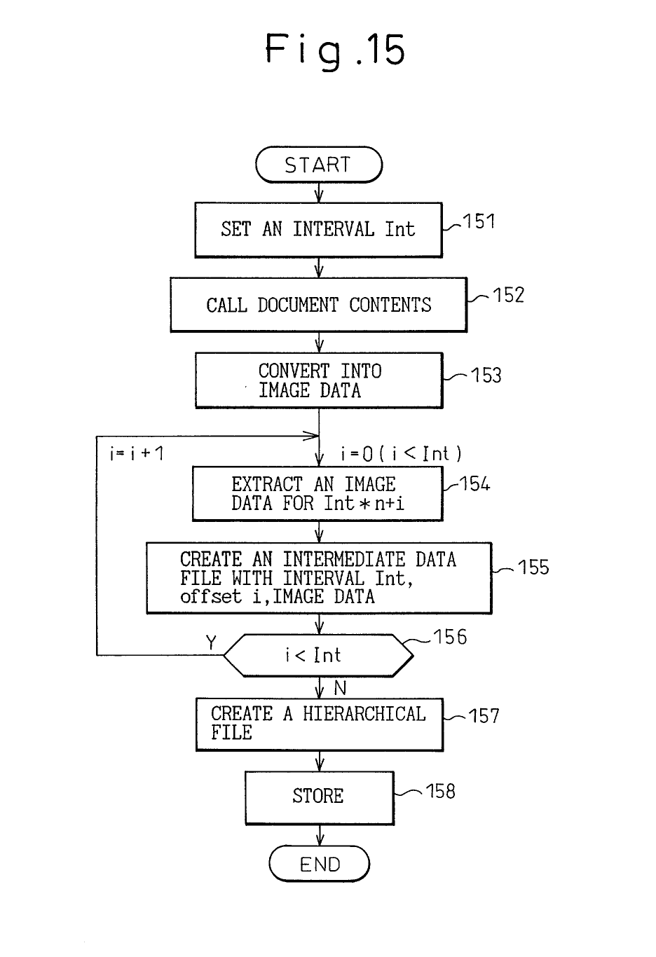

FIG. 15 is a flowchart explaining a method of creating a hierarchical file according to the sixth embodiment of the present invention. In the figure, in step 151, intervals In for thinning-out are set, in step 152, document contents are called from the contents storage unit 502 within the portable server division 500, and in step 153, the document contents are converted into image data. Next, in step 154, every time an address=Int*n+i(i<Int, where n is a natural number), image data is extracted, and in step 155, an intermediate data file of one hierarchy is created from image data for the interval Int, offset i. Next, in step 156, whether or not i is smaller than Int is determined, and if i is determined to be smaller than Int, i is then incremented, and steps 154 and 155 are repeated. In step 156, when i is determined to be equal to Int, then the process advances to step 157, where an intermediate data file of a plurality of hierarchies is created. Then, in step 158, the hierarchical file so created is stored in the contents storage unit 502 or the memory (not shown in FIG. 5).

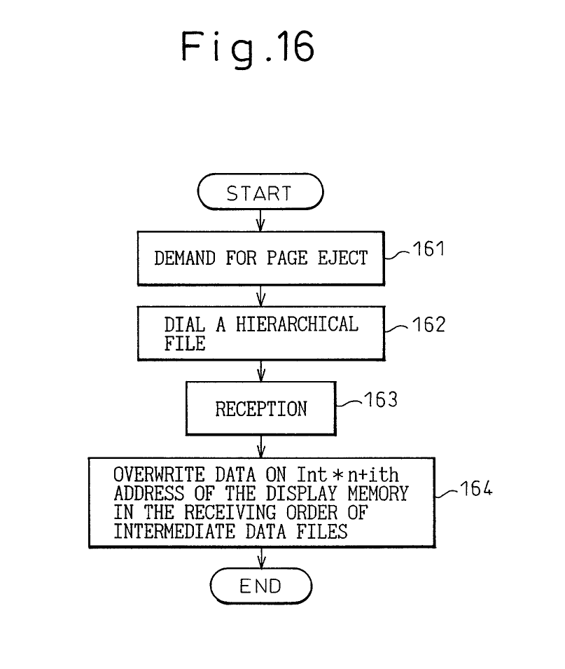

FIG. 16 is a flowchart explaining a browsing method of the hierarchical file according to the sixth embodiment described above. In the same figure, step 161 to step 163 are identical to step 101 to 103 described in FIG. 10, and therefore, a description thereof will be omitted. At the viewer division 510, in step 164, data are overwritten on the Int*n+ith address of the image memory in the order in which intermediate data files are received.

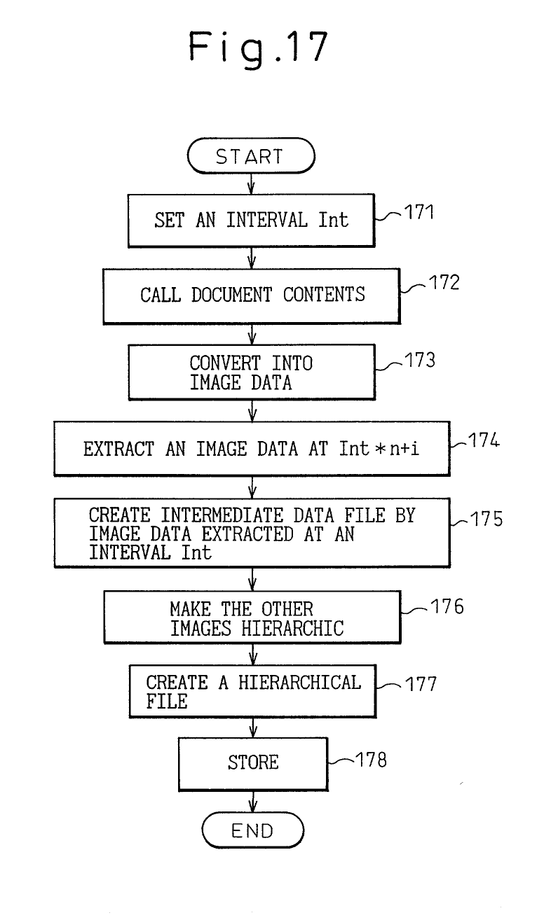

FIG. 17 is a flowchart explaining a creating method of a hierarchical file of two hierarchies comprising an image thinned-out at Int intervals and the other image data according to the sixth embodiment described above. In the figure, steps 171 to 175 are identical to steps 151 to 155 of FIG. 15 except that i is not modified, and therefore, a description thereof will be omitted. In step 175, an intermediate data file of one hierarchy is created by image data extracted at an interval int. In step 176, images other than the image layered in step 175 are layered. In step 177, a hierarchical file is created from the intermediate data files of two hierarchies created as described above, and in step 177, the hierarchical file so created is then stored in the contents storage unit 502 or the memory (not shown in FIG. 5).

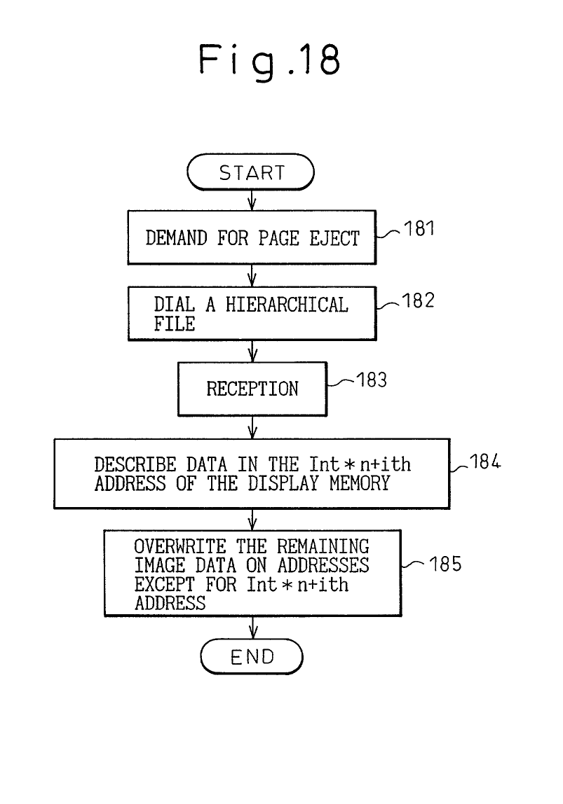

FIG. 18 is a flowchart explaining a method of browsing the hierarchical file created according to the flowchart of FIG. 17. In the same figure, step 181 to step 183 are identical to steps 161 to 163 described in FIG. 16, and therefore, a description thereof will be omitted. At the viewer division 510, in step 184, thinned-out data is written in the Int*+ith address of the display memory 512 and in step 185, the remaining image data are overwritten on addresses other than the Int*+ith address.

According to the sixth embodiment, since the thinned-out display is effected, the whole image of the contents can be displayed at high speed.

Next, a seventh embodiment of the present invention will be described. According to the seventh embodiment, an intermediate data file is configured by converting character information which is gradated, with a view to suppressing jaggies in an image, into a binary image. The viewer division 510 has a character gradation processing function, and after the binary image is displayed, the image is then graded for re-display.

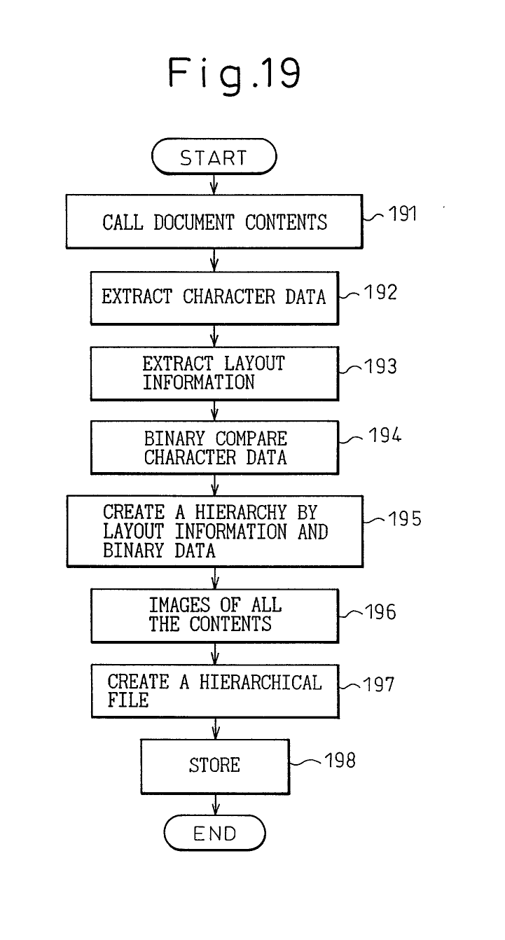

FIG. 19 is a flowchart explaining the seventh embodiment. In the figure, in step 191, document contents are called from a contents storage unit such as the contents storage unit 502, in step 192, character data is extracted from the document contents by the computer processing division 501, in step 193, layout information is extracted from the document contents, and in step 194, the character data which is gradated is made to be binary. Next, in step 195, hierarchical data is created from the layout information and the binary data. Next, in step 196, images of all the contents which are gradated in, for example, 24 bits, are made to be the following hierarchical data. Then, in step 197, a hierarchical file is created from the binary hierarchical data and the gradated hierarchical data, and in step 198, the hierarchical file is stored in the contents storage unit 502 or the like.

When trying to transmit the gradated character data to the viewer division 510 as it is, because the data volume is large, it takes a long time. However, with the binary character data, since the data volume is small, the data can be sent to the viewer division 510 within a short period of time.

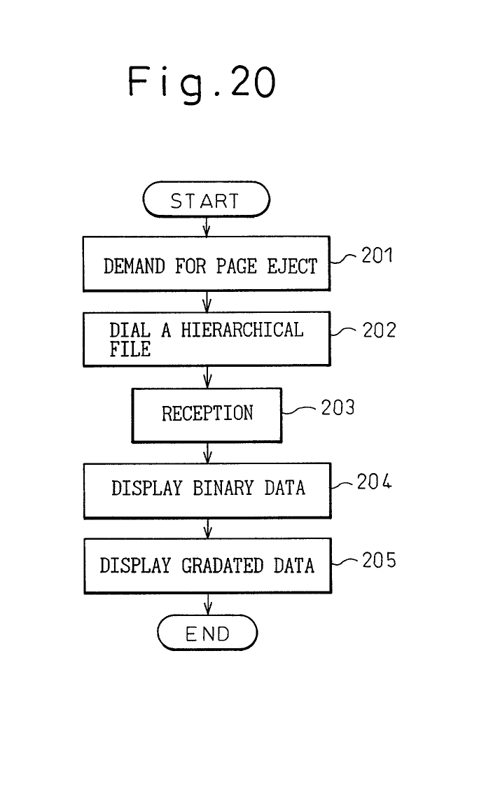

FIG. 20 is a flowchart explaining a browsing method of the hierarchical file created according to the flowchart of FIG. 19. In the figure, in step 201, a page call signal is transmitted through the wireless interface 513 from the viewer division 510 to the portable server division 500 (demand for page eject). Next, in step 202, on the portable server division 500 side, when the page call signal is received, a hierarchical file is transmitted through the wireless inter face 503. In step 203, when the viewer division 510 receives the hierarchical file, in step 204, a binary image is first displayed, and next, in step 205, the gradated data are overwritten on the display memory 512, whereby the user can be aware of the summary of the relevant page without delay by looking first at the display of the binary image.

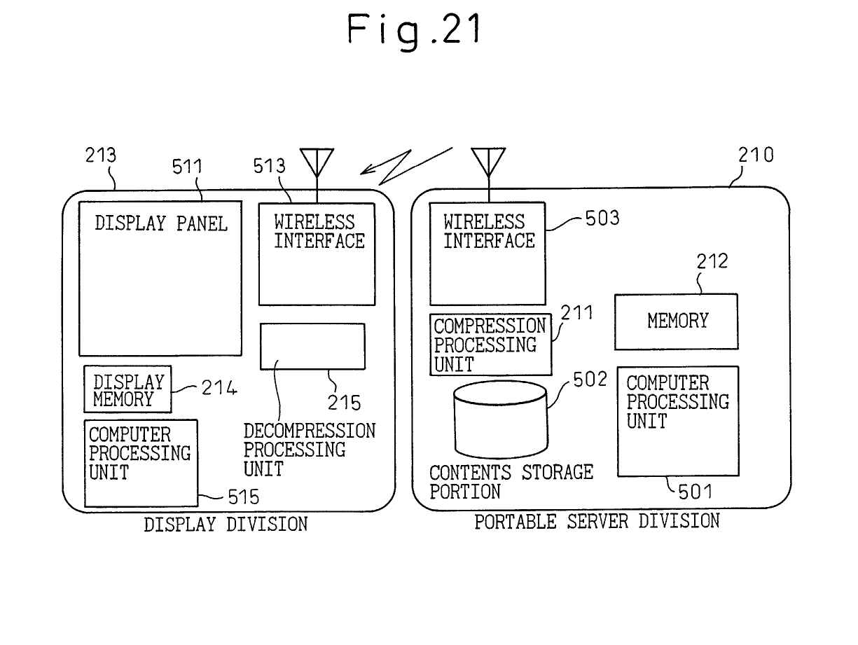

FIG. 21 is a block diagram showing the configuration of a portable electronic viewer system according to an eighth embodiment of the present invention. In the same figure, like reference numerals are imparted to like components to those shown in FIG. 5, and the description thereof will be omitted here. In this embodiment, a compression processing unit 211 and a memory 212 are provided in a portable server unit 210, and a memory 214 and a decompression processing unit 215 are provided in a viewer division 213.

According to the eighth embodiment, the viewer division 213 has a compressed data decompressing function. Page image data is data compressed page by page at the portable server division 210 and, after the compressed images are transferred, the compressed images so transferred are expanded by the compressed data decompressing function for display at the viewer division 213.

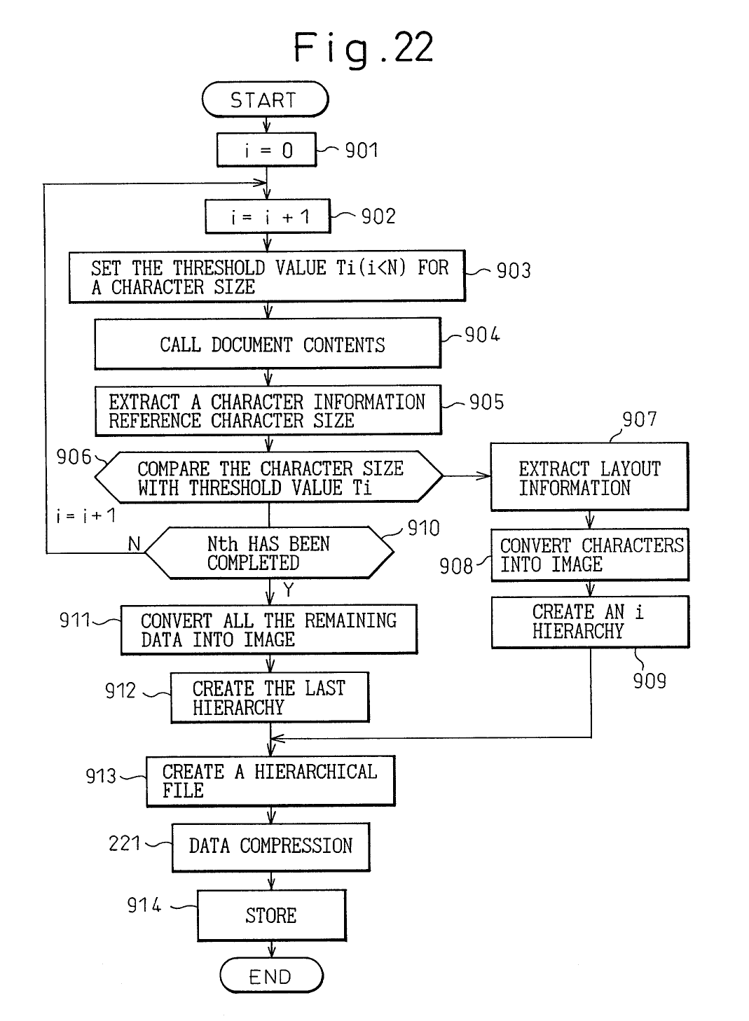

FIG. 22 is a flowchart explaining a creating method of the hierarchical file according to the eighth embodiment described above. In the same figure, most of the processes are identical to those of the third embodiment shown in FIG. 9, like reference numerals are imparted to like processes, and a description thereof is omitted here. In the embodiment, after the hierarchical file is created in step 913, in step 221, a compression process is performed on the hierarchical file by the compression processing unit 211. The computer processing unit 501 may perform the compression process instead of the compression processing unit 221. The compressed hierarchical file is stored in the contents storage unit 502 or the memory 212 in step 914.

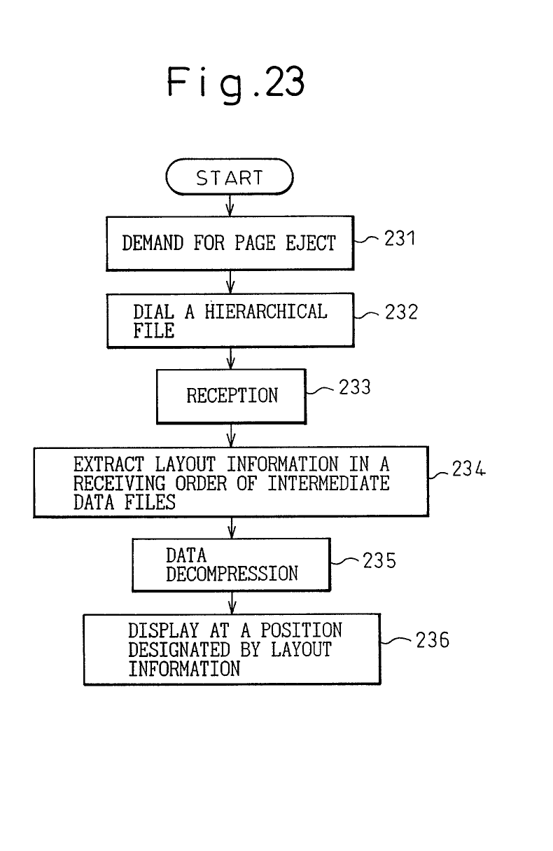

FIG. 23 is a flowchart explaining a method of browsing the compressed hierarchical file created according to the flowchart of FIG. 22. In the same figure, step 231 to step 233 are identical to step 101 to step 103 in FIG. 10 except that the compressed hierarchical file is transmitted and received, and therefore, a description of the steps will be omitted here. The viewer division 213 extracts layout information in step 234 in the order in which the compressed intermediate data files are received, and in step 235, a data decompressing process is carried out. Then, in step 236, the decompressed hierarchical files are described in the display memory 214. Note that the description to the display memory 214 is performed relative to an address designated by the layout information. In step 236, character images are displayed at positions designated by the extracted layout information.

According to the eighth embodiment, since the intermediate data files are compressed to be transmitted from the portable server division to the viewer division, even if the transfer rate of the wireless interface is limited, the data can be transferred efficiently.

Next, a ninth embodiment of the present invention will be described.

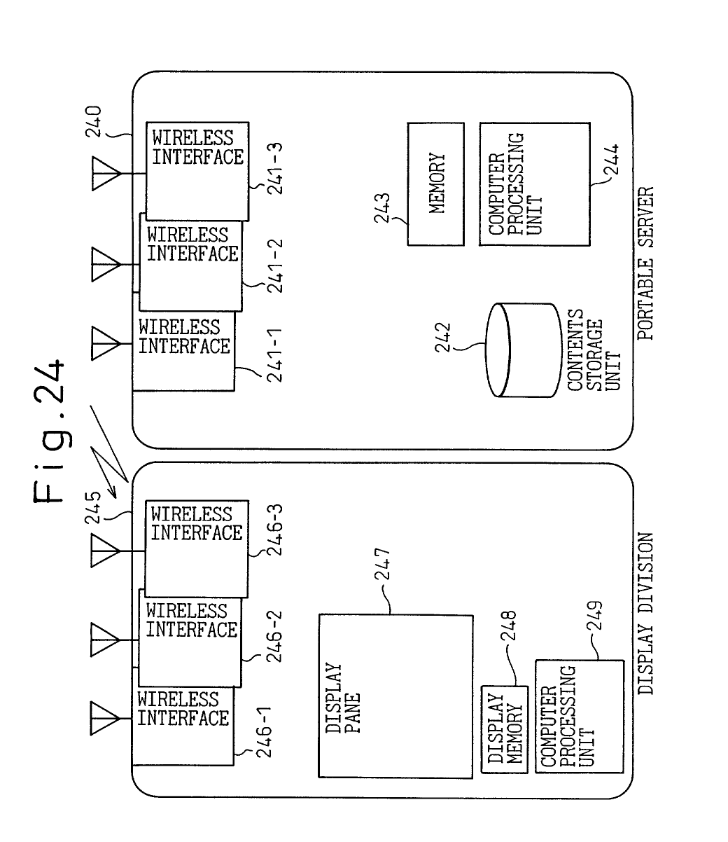

FIG. 24 is a block diagram showing the configuration of the portable electric viewer system according to the ninth embodiment of the present invention. In the same figure, a portable server 240 comprises a plurality of (three in the figure) wireless interfaces 241-1, 241-2 and 241-3, a contents storage unit 242, a memory 243 and a computer processing unit (CPU) 244.

According to the ninth embodiment, the portable server division 240 divides an intermediate data file constituted by an page image of units of pages into an equal number of intermediate data files to the number of wireless interface modules 241-1 to 241-3 and thereafter transfers data from the plurality of wireless interface modules 241-1 to 241-3 in the order in which the divided intermediate data files are written, while the viewer division 245 writes in the display memory 248 the transferred intermediate data files following the data writing order.

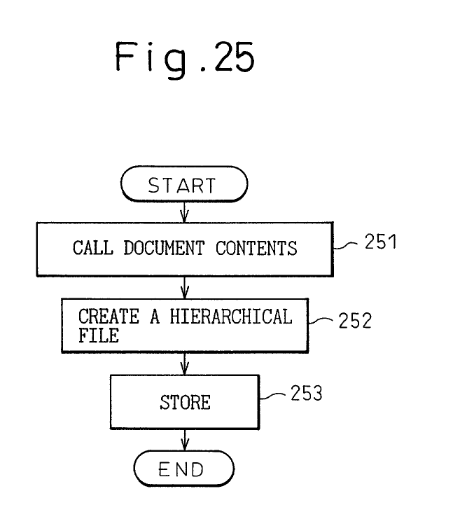

FIG. 25 is a flowchart explaining a creating method of the hierarchical file according to the ninth embodiment. In the same figure, in step 251, document contents are called from the contents storage unit 242, in step 252, one hierarchical file is created, and in step 253, the hierarchical file is stored in the contents storage unit 242 or the memory 243. The other hierarchical files are also created in accordance with the flowchart in FIG. 25.

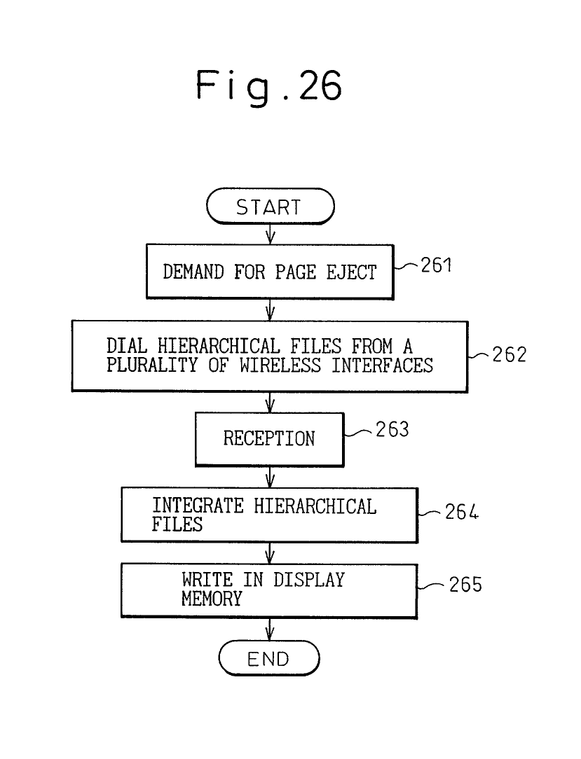

FIG. 26 is a flowchart explaining a method of browsing the plurality of hierarchical files created in accordance with the flowchart in FIG. 25. In the figure, in step 261, a plurality of page call signals are transmitted through a plurality of wireless interfaces 246-1 to 246-3, whereby a plurality of demands for page eject are made in parallel relative to the portable server division 240. In step 262, the portable server division 240 which has received the plurality of demands for page eject transmits a plurality of hierarchical files in parallel through the plurality of wireless interfaces 241-1 to 241-3. Each of the hierarchical files comprises an intermediate data file of a plurality of hierarchies, as with the intermediate data file in each of the previous embodiments. Next, in step 263, the viewer division 245 receives the plurality of hierarchical files, in step 264, the plurality of hierarchical files are integrated, and in step 265, the hierarchical files are written in the display memory 248 following the data writing order.

Thus, since the hierarchical file can be divided into a plurality of hierarchical files for parallel transfer, the transfer rate can be increased.

In this embodiment, the hierarchical data file may be such that the document contents called from the contents storage unit 242 are physically sequentially divided from the top of the data addresses into a number files corresponding to the number of interfaces for transmission thereof.

According to the ninth embodiment, the problem associated with the limited transfer rate can be solved by utilizing a number of wireless interfaces.

Next, a tenth embodiment according to the present invention will be described.

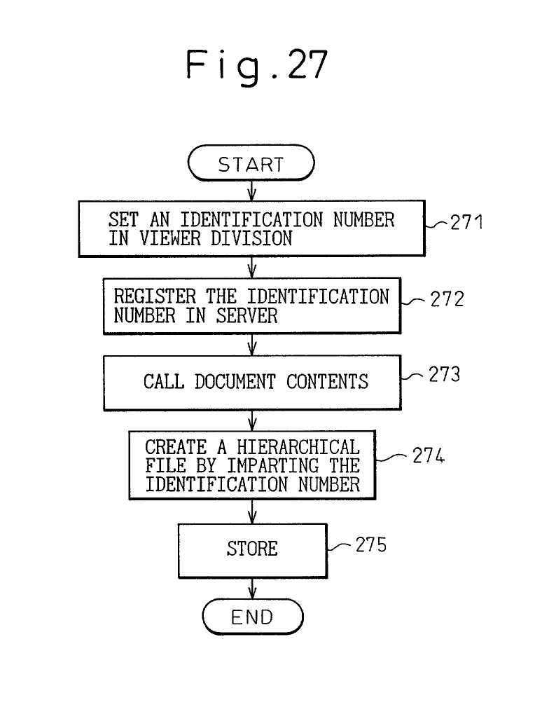

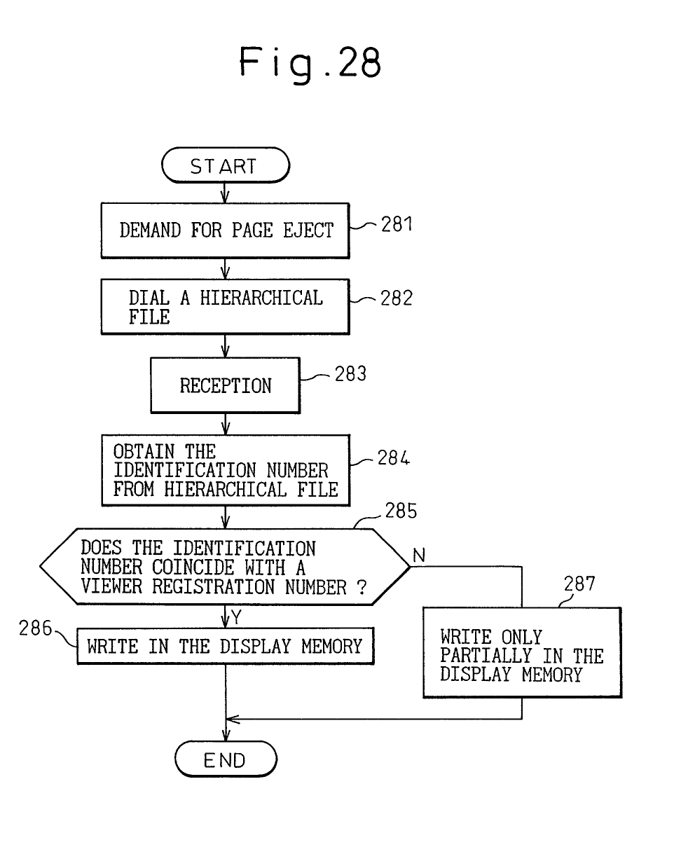

FIG. 27 is a flowchart explaining a creating method of a hierarchical file according to the tenth embodiment, and FIG. 28 is a flowchart explaining a browsing method of the hierarchical file created according to the flowchart in FIG. 27.

As shown in FIG. 27, in the embodiment, a specific identification number is set to the viewer division 510 in the system shown in FIG. 3 in step 271 and, in step 272, this identification number is registered in advance in the portable server division 500. Then, in step 273, document contents are called from the contents storage unit 502, in step 274, identification numbers are imparted respective intermediate data files to create a hierarchical file, and in step 275, this hierarchical file is stored in the contents storage unit 502 or the memory. In this case, too, the hierarchical file comprises a plurality of hierarchies of intermediate data files.

In browsing, as shown in FIG. 28, in step 281, the viewer division 510 demands a page eject, in step 282, the portable server 500 dials the hierarchical file, in step 283, the viewer division 510 receives the hierarchical file so dialed, and in step 284, the identification numbers are obtained from the intermediate data files in the hierarchical file. Then, in step 285, when the identification numbers of the intermediate data files in the hierarchical file sent to the viewer division 510 coincide with the identification numbers that the viewer division 510 has, the data on the intermediate data files are described in the display memory 512.

Thus, security is secured between the portable server division and the viewer division.

Note that, in the event that the identification numbers are determined to be inconsistent with each other in step 285 in FIG. 28, in step 287, only the intermediate data files on part of the hierarchies are displayed, and the intermediate data files on the lower layers may be described in the display memory 512 only when the identification numbers are determined to coincide with each other, whereby the system can be applied to a service in which all characters and images are supplied with users only whose identification numbers are registered.

Next, an eleventh embodiment according to the present invention will be described.

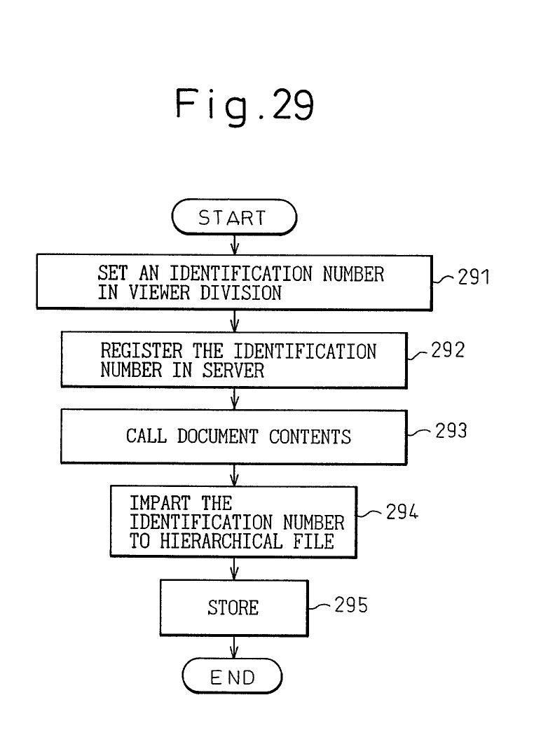

FIG. 29 is a flowchart explaining a creating method of a hierarchical file according to the eleventh embodiment of the present invention. In the same figure, in step 291, an identification number is set in the viewer division 510, and in step 292, this identification number is transferred from the viewer division 510 to the portable server division 500, so that the identification number is registered in the portable server division 500. next, in step 293, the portable server division 500 calls document contents from the contents storage unit 502 and, in step 294, the identification number is imparted to the intermediate data files of the hierarchical file created at the computer processing unit 501 in accordance with the methods in the respective previous embodiments. In step 295, this hierarchical file is retained in the contents storage unit 502.

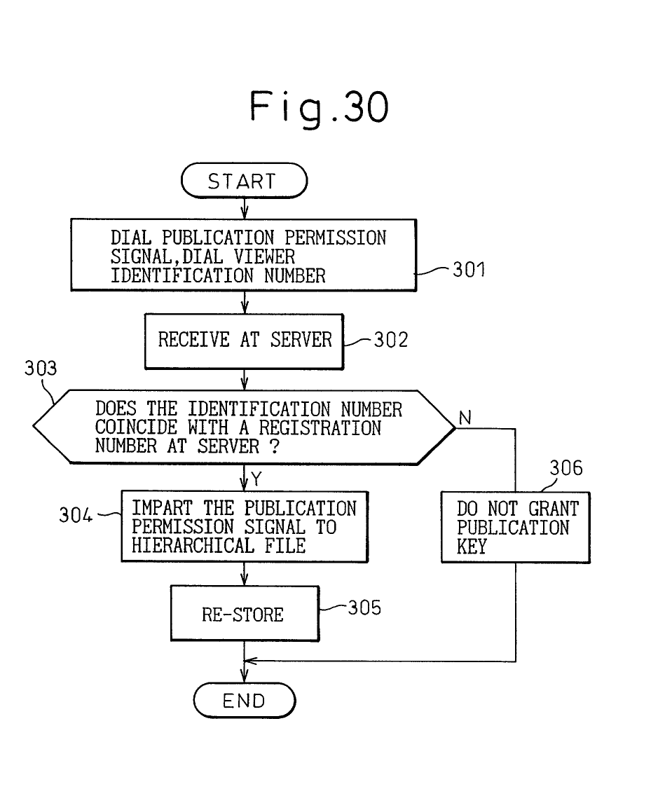

With respect to the eleventh embodiment, FIG. 30 is a flowchart explaining the flow of a process in which the viewer division 510 grants permission for the publication of contents. In the same figure, in step 301, the viewer division transmits a publication permission signal and a viewer's identification number to the portable server division 500. Next, in step 302, the portable server division 500 receives the signals. Then, in step 303, whether or not the identification number registered at the portable server division and the identification number received thereby coincide with each other is determined. In the event that they are determined to coincide with each other, in step 304, a publication permission signal is granted to the hierarchical file, and in step 305, the identification number is then restored in the contents storing unit 502. On the contrary, in the event that the numbers are inconsistent with each other, then, in step 306, the process is terminated without granting a publication key to the hierarchical file.

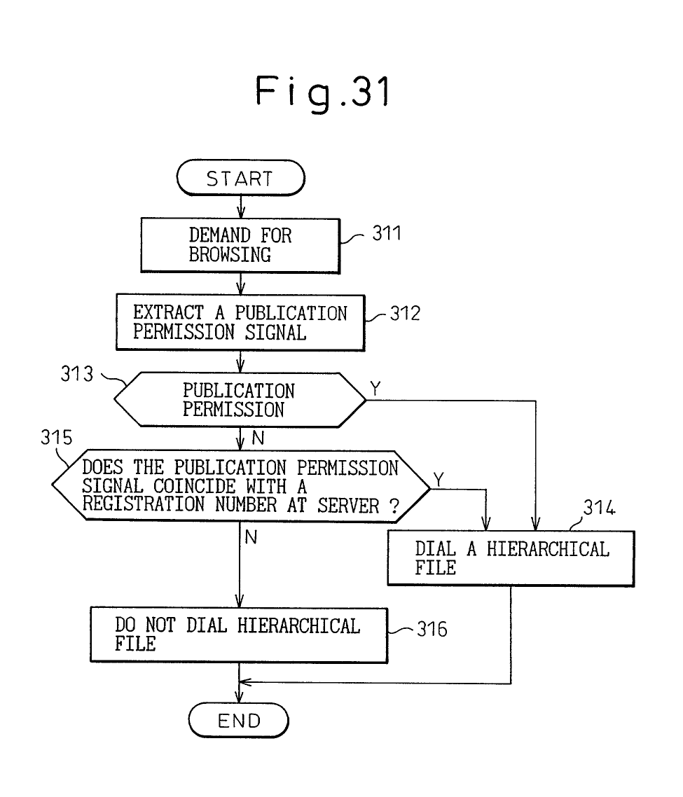

With respect to the eleventh embodiment, FIG. 31 is a flowchart explaining the flow of a process in which the portable server transmits a hierarchical file.

In the same figure, in step 311, an optional viewer division transmits a page eject signal and a viewer identification number through the wireless (demand for browsing). On the portable sever division 500 side, when the same signal is received, in step 312, the publication permission signal of the hierarchical file corresponding to the signal is extracted. Then, in step 313, whether or not the publication permission numeral is imparted to the hierarchical file is determined. In the event that the publication permission number is determined to have been imparted to the hierarchical file, in step 314, a hierarchical file is transmitted. In the event that the publication permission signal is not imparted thereto, in step 315, the identification number registered in the portable server division 500 is collated with the received identification number, and in the event that they coincide with each other then, in step 324, the hierarchical file is transmitted. The viewer division demanding for browsing then receives the hierarchical file through the wireless interface. In the event that they are determined to be inconsistent with each other in step 315, the portable server division 500 does not transmit the hierarchical file in step 316.

Thus, when trying to access the portable server division 500 from a plurality of viewer divisions, the viewer divisions are prioritized. For example, in a case where a single holder holds the portable server division and the viewer division, the highest priority is granted to the viewer division.

Next, a twelfth embodiment according to the present invention will be described.

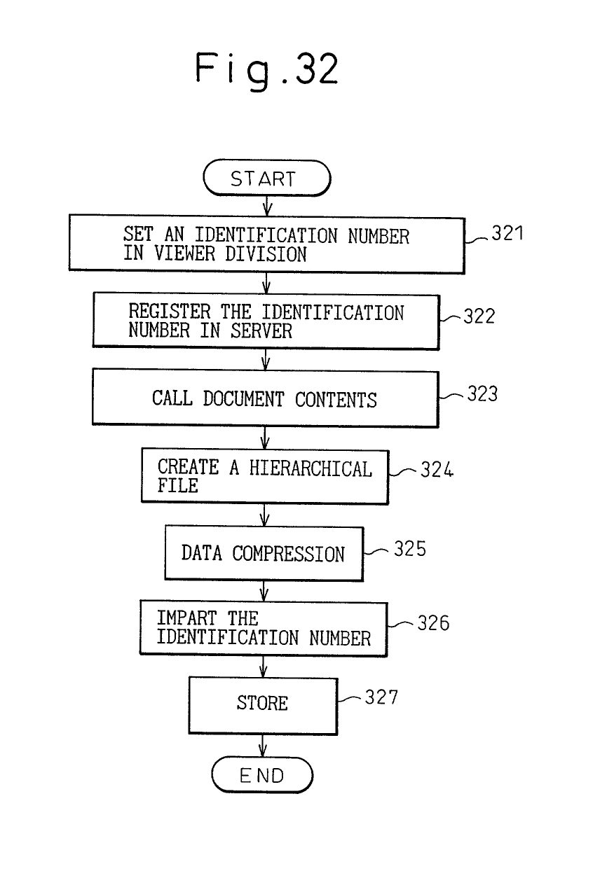

FIG. 32 is a flowchart explaining a creating method for a hierarchical file according to the twelfth embodiment of the present invention. A system for realizing this embodiment is identical to that shown in FIG. 21. In FIG. 32, in step 321, an identification number is set in the viewer division 213, and in step 322, this identification number is transmitted from the viewer division 213 to the portable server division 210, so that the identification number so transmitted is registered in the portable server division 210. Next, in step 323, the portable server division 210 calls document contents from the contents storage unit 502, and in step 324, a hierarchical file is created by the computer processing unit 501 using the methods described in the respective previous embodiments. Next, in step 325, data compression is performed and, in step 326, the identification number is imparted to the compressed hierarchical file. In step 327, the hierarchical file is retained in the contents storage unit 502.

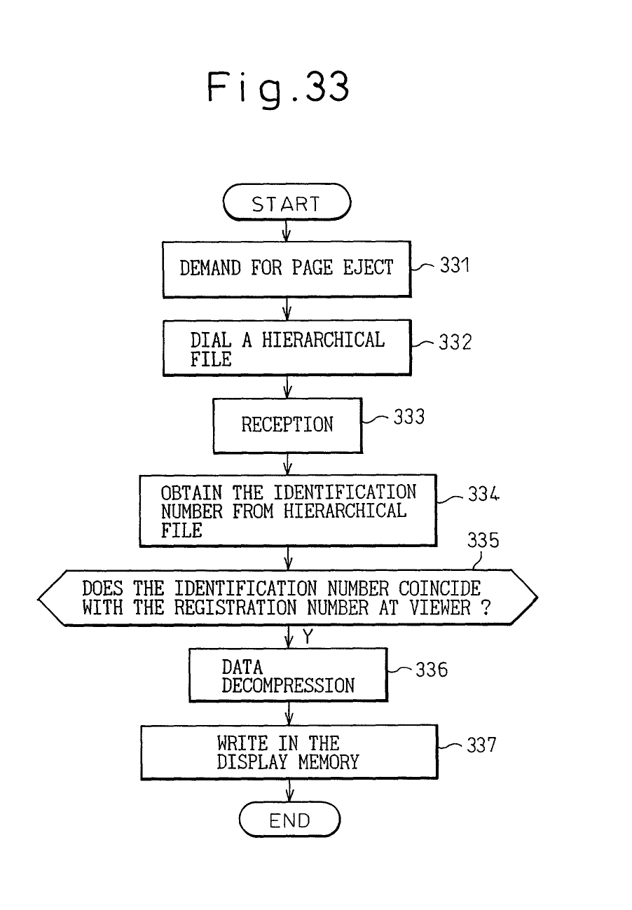

FIG. 33 is a flowchart explaining a method of browsing the compressed hierarchical file created in accordance with the flowchart shown in FIG. 32. In the same figure, in step 331, a page call signal is transmitted from the viewer division 213 through the wireless interface 513, whereby a page eject demand is made relative to the portable server division 210. Following this, in step 332, when the portable server division 210 receives the signal, then, in step 334, the identification numbers are obtained from the intermediate data files in the hierarchical file, and in step 335, whether or not the registration number held by the viewer division 213 coincides with the identification number extracted from the received hierarchical file is determined, and in the event that they are determined to coincide with each other, then, in step 337, the decompression of the data is performed, and in step 337, the decompressed hierarchical file is described in the display memory 214.

According to the twelfth embodiment, since the viewers that can be used for display are limited, the security level can be improved.

What is claimed is:

1. A portable electronic viewer system comprising a server division for transmitting and receiving book-type contents having page-by-page information containing at least either images or characters and a viewer division for displaying said book-type contents transmitted from said server division page by page.

2. A portable electronic viewer system as set forth in claim 1, wherein said viewer division comprises a display panel for displaying said book-type contents page by page, a display memory for storing page-by-page information that is to be displayed on said display panel, a first wireless interface module and a first battery for supplying power to said display panel and said display memory, and wherein
said server division comprises a disk for storing said book-type contents, a second wireless interface module for performing wireless communications with said first wireless interface module of said viewer division, a computer processing unit for creating page-by-page information from said book-type contents stored in said disk, and a second battery for supplying power to said disk, said second wireless interface module and said computer processing unit.

3. A portable electronic viewer system as set forth in claim 2, wherein said computer processing unit consisting of said server division converts a data file having at least one of a document layout, document information, character information and image information into an intermediate data file constituted by part of information in an image in which a page constitutes a unit and transfers said intermediate data file so converted to said viewer division using said second wireless interface, and wherein said viewer division displays a page-by-page image by describing said intermediate data file in said display memory.

4. A server division for storing book-type contents containing at least either images or characters and transmitting said book-type contents to a viewer division wirelessly.

5. A viewer division for displaying book-type contents containing at least either images or characters which are sent wirelessly from a server division page by page.

6. A portable electronic viewer system as set forth in claim 2, wherein said intermediate data file is constituted by a plurality of hierarchies, whereby said intermediate data file is sequentially transferred hierarchy by hierarchy in transferring images, and wherein said viewer division describes said intermediate data file in said display memory every time said intermediate data is transferred thereto.

7. A portable electronic viewer system as set forth in claim 6, wherein said intermediate data file is configured by layering character information of original image information in accordance with the size of character font, so that priority in transfer is granted to intermediate data files in which larger-sized characters are layered.

8. A portable electronic viewer system as set forth in claim 6, wherein said intermediate data file is created by separating a hierarchy of an image for an element of green of a color image from other hierarchies of images for elements of colors other than green.

9. A portable electronic viewer system as set forth in claim 6, wherein said intermediate data file is configured by different hierarchies of image portions and character portions, and wherein priority in transfer is given to intermediate data files on said hierarchies of image portions.

10. A portable electronic viewer system as set forth in claim 6, wherein said viewer division has a function to write in said display memory for each address which is a certain interval away from a transferred intermediate data file, and said portable server division configures an intermediate data file in which data are layered for each address having an interval identical to said certain interval.

11. A portable electronic viewer system as set forth in claim 6, wherein said intermediate data file is configured by converting character information into a binary image, wherein said viewer division has a character gradation processing function, so that said binary image is gradated after being displayed for redisplay.

12. A portable electronic viewer system as set forth in claim 1, wherein said viewer division has a compressed data decompressing function, wherein a page image in which a page constitutes a unit is data compressed at said portable server division and wherein, after transferring said compressed image, said transferred compressed image is expanded for display by said compressed data decompressing function at said viewer division.

13. A portable electronic viewer system as set forth in claim 1, wherein said viewer division has a compressed data decompressing function, wherein an intermediate data file in which a page image, in which a page constitutes a unit, is layered is data compressed at said portable server division, wherein after said compressed intermediate data file has been transferred, said transferred compressed image is expanded by said compressed data decompressing function at said viewer division, and wherein hierarchical data so transferred is displayed every time said data is transferred.

14. A portable electronic viewer system as set forth in claim 3, wherein said portable server division and said viewer division each have a plurality of said wireless interface modules, and wherein said portable server division divides an intermediate data file constituted by a page image, in which a page constitutes a unit, into a number of intermediate data files equal to the number of said wireless interface modules and thereafter transfers from said plurality of wireless interface modules said divided intermediate data files and data indicating a writing order of said divided intermediate data files, while said viewer division writes in said display memory said intermediate data files so transferred following said data writing order.

15. A portable electronic viewer system as set forth in claim 3, wherein said viewer division has its own specific identification number, wherein said identification number is registered in advance in said portable server division and wherein said identification number is described in an intermediate data file, whereby when the identification number of an intermediate data file sent to said viewer division coincides with the identification number that said viewer division possesses, the data is described in said display memory.

16. A portable electronic viewer system as set forth in claim 6, wherein said viewer division has its own specific identification number, wherein said identification number is registered in advance in said portable server division and wherein said identification number is described in an intermediate data file, whereby when the identification number of an intermediate data file sent to said viewer division coincides with the identification number that said viewer division possesses, hierarchical data on a lower layer is described in said display memory.

17. A portable electronic viewer system as set forth in claim 15 or 16, wherein a signal comprising the identification number of said viewer division is transmitted from said viewer division to said portable server division, wherein when said signal is received at said portable server division, said signal is collated with the identification number of a viewer registered therein and wherein when said collation determines that said identification numbers coincide with each other, a publication signal is described in an intermediate data file.

18. A portable electronic viewer system as set forth in claim 12 or 13, wherein said viewer division has its own specific identification number, wherein said identification number is registered in advance in said portable server division and wherein said identification number is described in an intermediate data file, whereby when the identification number of an intermediate data file sent to said viewer division coincides with the identification number that said viewer division holds, a compressed data is decompressed.
